(19) United States
(12) Patent Application Publication
(10) Pub. No.: US 2019/0278800 A1
(43) Pub. Date: Sep. 12, 2019

(54) SYSTEM AND METHOD FOR IMAGERY MNEMONIC CREATION

(71) Applicant: KONINKLIJKE PHILIPS N.V., ElNDHOVEN (NL)

(72) Inventors: PAUL MICHAEL FULTON, CAMBRIDGE (GB); ASTHA SAXENA, ROTHERHAM (GB)

(21) Appl. No.: 16/302,365

(22) PCT Filed: May 23, 2017
(86) PCT No.: PCT/EP2017/062463

§ 371 Date: Nov. 16, 2018

Related U.S. Application Data
(60) Provisional application No. 62/340,809, filed on May 24, 2016.

(51) Int. Cl. G06F 16/535; G06F 16/51; G06F 16/538; G06F 16/583; G06N 20/00; G10L 15/22; G10L 15/26; G06F 17/27; G06T 7/70; G06T 11/60; G06T 7/10

(52) U.S. Cl. CPC G06F 16/535; G06T 2207/20081; G06F 16/538; G06F 16/583; G06N 20/00; G10L 15/22; G10L 15/265; G06F 17/273; G06F 17/274; G06F 17/2795; G06T 7/70; G06T 11/60; G06T 7/10; G06T 2207/20221; G06F 16/51

(57) ABSTRACT

A method for generating an imagery mnemonic is described herein. The method includes receiving at least two words of interest. The method further includes evaluating the at least two words to determine what entities they represent, and identifying one of the at least two words as a subject word and another of the at least two words as an 5 object word using a subject-object model. The method further includes searching a database of images for images corresponding to the at least two words. The method further includes identifying a classifier for the at least two words, and classifying the images including identifying a first image that includes the entity represented by the subject word and a second image that includes the entity represented by the object word. The method further includes 10 creating an imagery mnemonic by combining the first and second images.

### FIELD OF THE INVENTION

The following generally relates to imagery mnemonic and in particular to creating an imagery mnemonic.

### BACKGROUND OF THE INVENTION

Imagery mnemonic is a memory technique that employs a form of visual cue or prompt in order to help a user of the mnemonic remember a specific detail. The representation could be either directly or indirectly related to the idea that is trying to be memorized. The imagery mnemonic technique can be applied to tasks such as remembering lists, prospective memory and/or language learning. A difficulty of imagining an effective imagery mnemonic is dependent upon the creativity of the individual, and it can take a long time to visualize tasks in the form of composite images which trigger recall.

There is training available which helps to generate an imagery mnemonic; however, the training can be a lengthy process and is prone to failure, for example, due to the lack of creativity by the creator of the composed images and/or the lack of effort put into following the training by the user. A dynamically generated, memorable image can help a user to learn how to use the imagery mnemonic. However, the creation of memorable images is a difficult task, for example, at least because a definition of a memorable image varies from individual to individual.

### SUMMARY OF THE INVENTION

Aspects described herein address the above-referenced problems and others.

In one aspect, a method for generating an imagery mnemonic includes receiving, via an input device of a computing system, at least two words of interest. The method further includes evaluating, with a processor of the computing system, the at least two words to determine what entities they represent, and identifying, with the processor, one of the at least two words as a subject word and another of the at least two words as an object word using a subject-object model. The method further includes searching, with the processor, a database of images for images corresponding to the at least two words. The method further includes identifying, with the processor, a classifier for the at least two words, and classifying, with the processor, the images including identifying a first image that includes the entity represented by the subject word and a second image that includes the entity represented by the object word. The method further includes creating, with the processor, an imagery mnemonic by combining the first and second images.

In another aspect, a computing system includes a memory device configured to store instructions, including an imagery mnemonic module, and a processor configured to execute the instructions. The instructions cause the processor to: receive at least two words of interest via an input device, evaluate the at least two words to determine what entities they represent, identify one of the at least two words as a subject word and another of the at least two words as an object word using a subject-object model, search a database of images for images corresponding to the at least two words, identify a classifier for each of the at least two words, classify the images from the search results, including identifying a subject image that includes the entity represented by the subject word and an object image that includes the entity represented by the object word, identify a location on the subject image for the object image, and create a composite image by merging the object image at the identified location on the subject image, wherein the composite image represents an imagery mnemonic.

In another aspect, a computer readable storage medium is encoded with computer readable instructions. The computer readable instructions, when executed by a processer, cause the processor to: receive at least two words of interest input via an input device, evaluate the at least two words to determine what entities they represent, identify one of the at least two words as a subject word and another of the at least two words as an object word using a subject-object model, search a database of images for images corresponding to the at least two words, identify a classifier for each of the at least two words, classify the images from the search results, including identifying a subject image that includes the entity represented by the subject word and an object image that includes the entity represented by the object word, identify a location on the subject image for the object image, and create a composite image by merging the object image at the identified location on the subject image, wherein the composite image represents an imagery mnemonic.

The invention may take form in various components and arrangements of components, and in various steps and arrangements of steps. The drawings are only for purposes of illustrating the embodiments and are not to be construed as limiting the invention.

### BRIEF DESCRIPTION OF THE DRAWINGS

FIG. 1 schematically illustrates an example computing system with an imagery mnemonic module.

FIG. 2 illustrates an example method for generating an imagery mnemonic.

FIG. 3 illustrates an example of an image corresponding to an input “subject” word.

FIG. 4 illustrates an example of an image corresponding to an input “object” word.

FIG. 5 illustrates an example of an imagery mnemonic created by combining the images corresponding to the input “subject” word and the input “object” word.

FIG. 6 illustrates a variation of FIG. 5 with a background image.

FIG. 7 illustrates a specific example method for generating an imagery mnemonic.

### DETAILED DESCRIPTION OF EMBODIMENTS

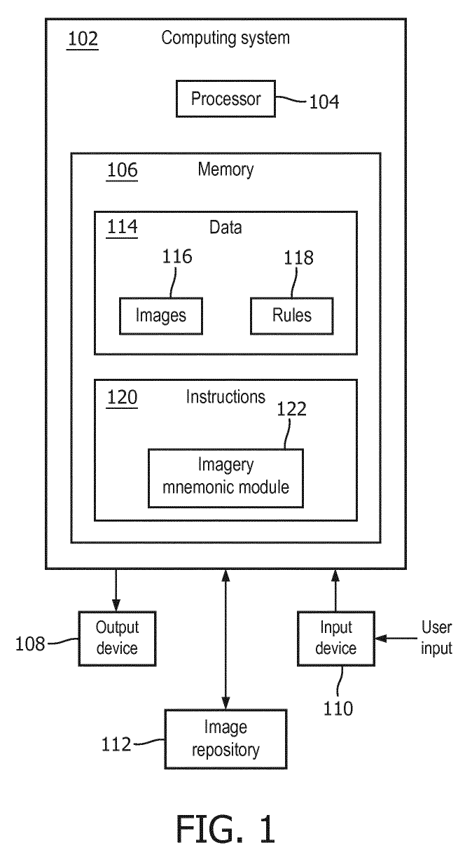

FIG. 1 illustrates an example computing system 102.

The computing system 102 includes a hardware processor 104 (e.g., a central processing unit or CPU, a microprocessor, or the like). The computing system 102 further includes a computer readable storage medium (“memory”) 106 (which excludes transitory medium) such as physical memory and/or other non-transitory memory. The computing system 102 further includes an output device(s) 108 such as a display monitor, a speaker, etc., an input device(s) 110 such as a mouse, a keyboard, a microphone, etc. The illustrated computing system 102 is in communication with a local and/or remote image repository 112, which stores images.

The memory 106 stores data 114, such as images 116 and rules 118, and computer readable instructions 120. The processor 104 is configured to execute the computer readable instructions 120. The computer readable instructions 120 include an imagery mnemonic module 122. The imagery mnemonic module 122 includes instructions, which, when executed by the processor 104, cause the processor 104 to create an imagery mnemonic using images (e.g., the images 116, the image repository 112, and/or other images) based on words input via the input device 110 and the rules 118. The image repository 112 may be local and/or remote (e.g., a server, “cloud,” etc.) accessed over a network such as the Internet.

In one instance, the imagery mnemonic module 122 includes a “subject-object” model to define the input words and generate the imagery mnemonic for the words. This includes having the processor 104 search for a keyword, within the input words, that is known and likely to be a main focus of the mnemonic. The processor 104 labels this keyword as the “subject.” The processor 104 labels the remaining words as “object” words. Generally, a “subject” word is a trigger/cue word, which the user is most likely to remember, e.g., a task that the user performs regularly and/or other word likely to be in their long term memory, and an “object” word is a word the user is less likely to remember. An image of the “object” word is merged with an image of the “subject” word at a particular location, creating an imagery mnemonic. This includes identifying the particular location(s) on the subject image, which acts as a background/base image, and the object word(s) is merged to identified location(s). The “subject” word/image acts as a trigger to help the user remember the “object” word/image.

For this, the imagery mnemonic module 122 employs a trained classifier to classify images corresponding to “subject” and “object” words. An example of a suitable classifier is a cascade classifier, which is a statistical model built up in layers over a number of training stages. With each training stage, the model becomes more specific to a point where it only detects that which it has been training on and nothing else. In one non-limiting example, a Haar Cascade Classifier is trained using an Open Source Computer Vision (OpenCV) library. A Haar Cascade Classifier uses Haar-like features (e.g., rectangular, tilted, etc.) as digital image features for object recognition. Other classifiers are also contemplated herein.

For training, the classifier is first trained to learn what an entity (e.g., a “dog’) is with a set of images that include the entity. Then, the entity is segmented (e.g., into “eyes,” “paws,” “body,” “tail,” “nose,” etc.), and the classifier is trained to learn what the different segments are with the segmentations. Different classification trees are created for different entities (e.g., “dog,” “apple,” “tooth,” etc.), and the classification trees are stored locally and/or remotely in a searchable database or the like. When creating an imagery mnemonic, the processor 104 utilizes, locally and/or remotely, a particular classifier of the database associated with the input words, and merges the “object” image at the particular location of the “subject” image. The classifier is used to classify the “subject” image and to determine a region of interest (ROI) on the “subject” image where the “object” image is eventually merged. An outline of an “object” image could be used to facilitate merging images, e.g., without knowing which part is which and/or how the object was oriented.

The imagery mnemonics can be stored (e.g., in the memory 106, the image repository 112, etc.), conveyed to another device (e.g., via a cable and/or wirelessly over a network, portable memory, etc.), printed to paper and/or film, and/or otherwise utilized. For example, the imagery mnemonics can be incorporated with paper and/or electronic calendars, to-do lists, diaries, etc. For instance, a composite image based on tasks to occur can be attached to a calendar entry in a smartphone, an email application, etc. The imagery mnemonics can help a person visualize their own imagery mnemonic and/or be used as their imagery mnemonic, and/or can be used for training purposes.

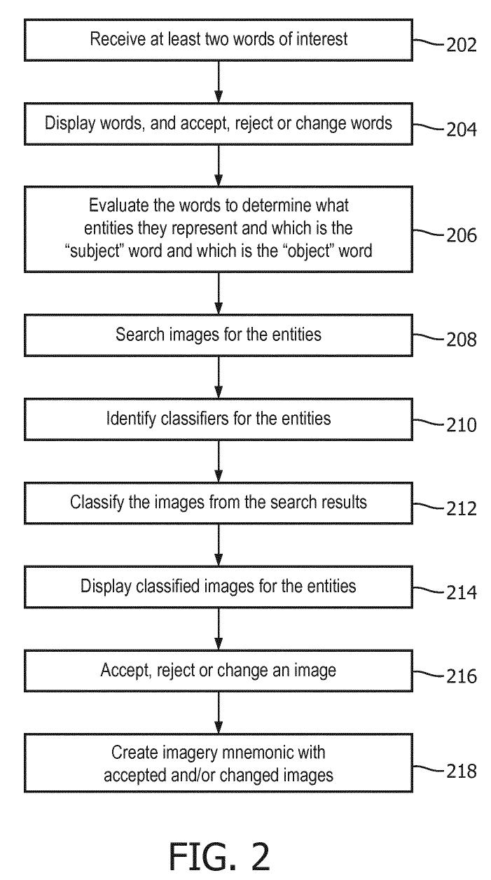

FIG. 2 illustrates an example method for generating an imagery mnemonic. It is to be appreciated that the ordering of the acts is not limiting. As such, other orderings are contemplated herein. In addition, one or more acts may be omitted and/or one or more additional acts may be included.

At 202, the system 100 receives at least two words of interest, e.g., through speech and/or text via the input device 110. If the words are entered via speech, the entered words are recognized and converted to text through speech recognition software of the system 100 and/or imagery mnemonic module 122. The imagery mnemonic module 122 may include instructions for performing a spell check operation on the entered words to ensure at least two words are input.

At 204, the words are displayed via the output device 108 and accepted, rejected and/or changed via an input from the input device 110.

At 206, the processor 104 evaluates the at least two words to determine what entities they represent, including determining which word is a “subject” word and which word is an “object” word.

By way of a non-limiting example algorithm, the system 102 checks to see if there already is a classifier for either or both of the words. If there is a classifier for only one word, then the system 102 identifies the word with the classifier as the subject word (and hence identifies the subject image) and the other word(s) as the object word(s). If there is a classifier for both words, then the system 102 determines which word has been searched more by the user and uses that word as the subject word. If the words are equally searched, then the system 102 prompts the user to identify the subject word to the system 102.

In one instance, the processor 104 uses a lexical database of English nouns, verbs, adjectives and adverbs grouped into sets of cognitive synonyms (synsets), each expressing a distinct concept, where the synsets are interlinked by conceptual-semantic and lexical relations, to determine a link between the at least two words. A non-limiting example of such a database is WordNet®. The order of the input can facilitate determining which word is a “subject” word and which word is an “object” word. Where the at least two words includes a sentence, the processor 104 can perform English parsing to interpret words such as “in” and “on.”

At 208, the processor 104 searches images in the images 116 and/or the image repository 112 for images that correspond to the entities represented by the at least two words. The search can be conducted using an application programing interface (API). A non-limiting example of an API is a Google Image Search application programing interface (API), which provides a JavaScript interface to embed Google Image Search results. Other API's include the Yahoo API, the Flickr API and/or other image search API. Alternatively, Google Custom Search, which enables creation of a search engine, can be used.

In one instance, image search API's are used as an image source for all of the images. For example, the images 116 are not searched. In this instance, the computing system 102 need not store the images 116. This may make the search process more flexible and imagery mnemonics can be made for any entities known. Where the images 116 are stored, the images 116 may include the user's gallery, which can be used to create the imagery mnemonics. This may help make imagery mnemonics more memorable and/or directly relevant to the context of the items being memorized.

At 210, classifiers are identified for the entities (i.e., the “subject” words). The classifiers are generated as described herein and/or otherwise.

At 212, the classifiers are used to classify the images from the search results, including identifying images including the entities represented by the words. The classification facilitates connecting or linking images to other images as it provides information about particular segments or sub-regions of an image.

At 214, the classified images for the entities are displayed via the output device 108.

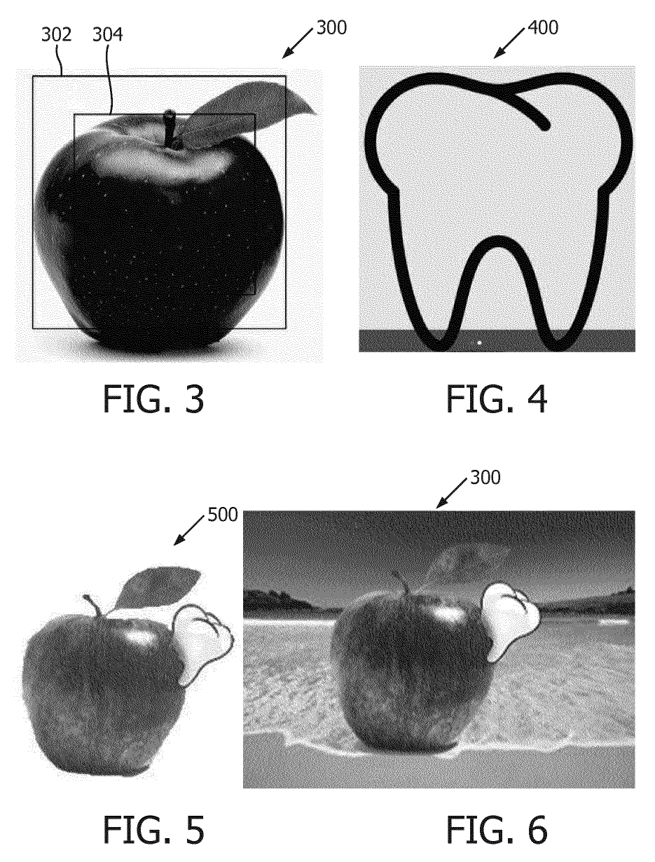

At 216, a signal indicating an image is accepted or rejected or identifying a different image is received. Briefly turning to FIGS. 3 and 4, FIG. 3 depicts an example of a first image 300 from the search corresponding to a “subject” word “apple,” and FIG. 4 depicts an example of a second image 400 from the search corresponding to an “object” word “tooth.”

Returning to FIG. 2, at 218, the processor 104 creates an image composition with the accepted and/or identified images as an imagery mnemonic. The imagery mnemonic can be a still image, animated, a video, a 3D image, etc.

In one non-limiting instance, an overlaying strategy is used for the composition based on a region of interest identified on the “subject” image for the “object” image. The processor 104 can use the information learned about the words from WordNet®, etc. for the composition. The processor 104 can perform the composition using techniques such as Poisson blending, etc. to create images. Other techniques include magic wand, stamping, blending, layer masking, clone tool, chopping large images into components, warping, flip tool, opacity change, etc.

By way of non-limiting example, turning to FIG. 3 a region of interest (ROI) 302 is identified on the “subject” image 300. A detection stage internally stores the ROI 302 within the “subject” image 300 in a form of a square around a detected area. A midpoint is calculated for the ROI 302, and the “object” image is overlaid at this point. For this, midpoints of the “subject” and “object” images are matched. If there is more than one “object” image, each “object” image is added to a different ROI in the “subject.” In one instance, this begins by randomly selecting an “object” image and adding it to the largest ROI 302. Then a next “object” image is added to a next largest ROI 304 in the “subject” image, and so on. The “subject” image is rendered pixel by pixel and the “object” image is added on top of the “subject” image using the overlaying strategy.

FIG. 3 shows the ROI being identified on the subject image. The detection stage internally stores the region of interests (ROI) within the subject image in the form of a square around the detected area. In the case of multiple ROI being detected, we have calculated the midpoint of the largest ROI and used this as the point at which the overlaying of the object image will occur. We make the second image transparent and calculate the midpoint. We match the midpoints of the subject and object images, which is where the overlaying occurs. If we have more than one object images, merging to the subject image, then we add each different object image to a different ROI in the subject image, by matching the midpoints. We start by randomly selecting an object image adding it to largest ROI. We then add the next object image to the next largest ROI in the subject image, and so on.

Turning to FIG. 5, an example of a composite image 500 or imagery mnemonic of an “apple-tooth” image is illustrated. In this example, the image of the “tooth” (FIG. 4) is merged at a particular location on the “apple” in the image of the “apple” (FIG. 3). FIG. 6 depicts an alternative example image 600 that includes the “apple-tooth” image of FIG. 5 with background imagery, which may be automatically and/or manually selected. The first, second and composite images can be black and white images (as shown) or color images. The imagery mnemonic is stored, conveyed to another device, printed, and/or otherwise utilized.

It is to be understood that the selection of the “subject” and “object” words does not have to be at the start. In instances where the “subject” and “object” words are first selected, the “subject” and “object” words are used to know something about the characteristics of each component image to make the whole set easier to combine. Alternatively, later in the process, after selecting images relating to each word and running the classifiers, another word can be chosen as the subject word. Generally, analysis of the input words and/or the classifiers can be used to select “subject” words, which lead to images in which key features are easily identifiable so that other images can be connected to them.

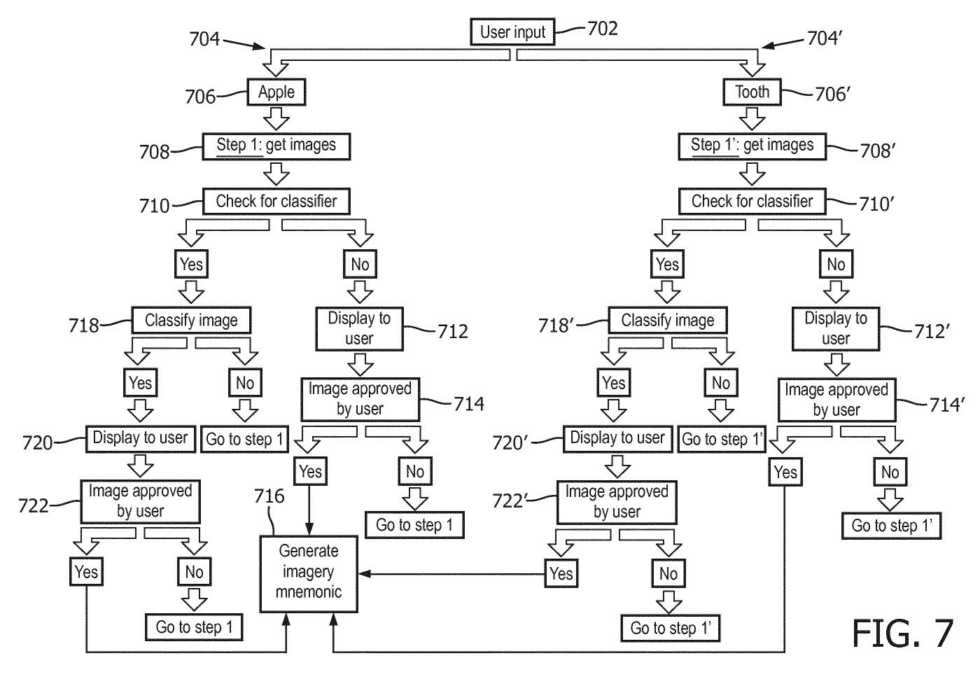

FIG. 7 illustrates another example method for generating an imagery mnemonic. For explanatory purposes, this example is described with the input “subject” word “apple” and the “object” word “tooth.”

It is to be appreciated that the ordering of the acts is not limiting. As such, other orderings are contemplated herein. In addition, one or more acts may be omitted and/or one or more additional acts may be included.

At 702, the system 100 receives input words “apple” and “tooth.” The two input words are processed in separate but similar processing chains 704 and 704′ as described next.

At 706 and 706′, the words are evaluated as described herein and/or otherwise to determine their meaning and to identify a “subject” image and an “object” image.

At 708 and 708′, images are retrieved for each of the two words as described herein and/or otherwise.

At 710 and 710′, the processor 104 checks to see if there is a classifier for each of the words.

If there is no classifier for one or both of the words, then at 712 and/or 712′ the images are displayed, and at 714 and/or 714′ the images are approved or rejected.

If approved for one or both of the words, then the accepted images are used for generating the imagery mnemonic at 716.

If rejected for one or both of the words, then acts 708 and/or 708′ are repeated for the rejected words.

If there is a classifier for one or both of the words, then at 718 and/or 718′, the images are classified.

If the classification fails for one or both of the words, then acts 708 and/or 708′ are repeated for the failed words.

If the classification succeeds for one or both of the words, then at 720 and/or 720′ the classified images are displayed, and at 722 and/or 722′ the images are approved or rejected.

If rejected for one or both of the words, then acts 708 and/or 708′ are repeated for the rejected words.

If approved for one or both of the words, then the accepted images are used for generating the imagery mnemonic at 716.

In another embodiment, the acts 720 and 722 and/or the acts 720′ and 722′ are omitted, and if the classification succeeds at 718 and/or 718′ for one or both of the words, then the classified images are used for generating the imagery mnemonic at 716, without user interaction and/or display of the images.

The method herein may be implemented by way of computer readable instructions, encoded or embedded on computer readable storage medium, which, when executed by a computer processor(s), cause the processor(s) to carry out the described acts. Additionally, or alternatively, at least one of the computer readable instructions is carried by a signal, carrier wave or other transitory medium.

The system and/or method describe herein is well-suited for applications such as, but not limited to, mental well-being to help a user visualize imagery mnemonics, a consumer calendar with auto generated images related to the content for each day would be a useful memory aid, home health care as part of a service, e.g., to help one remember day to day tasks, and education, e.g., for students who struggle to remember for their exams.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for generating an imagery mnemonic, the method comprising:
receiving, via an input device of a computing system, at least two words of interest;
evaluating, with a processor of the computing system, the at least two words to determine what entities they represent;
identifying, with the processor, one of the at least two words as a subject word and another of the at least two words as an object word using a subject-object model;
searching, with the processor, a database of images for images corresponding to the at least two words;
identifying, with the processor, a classifier for the at least two words;
classifying, with the processor, the images including identifying a first image that includes the entity represented by the subject word and a second image that includes the entity represented by the object word; and
creating, with the processor, an imagery mnemonic by combining the first and second images.

2. The method of claim 1, wherein the at least two words of interest are received as one of speech or text.

3. The method of claim 1, wherein at least one of the at least two words of interest is received as speech, further comprising:
recognizing the speech with a speech recognition algorithm; and
converting to recognized speech to text with the speech recognition algorithm.

4. The method of claim 1, further comprising:
employing a spell check operation on the received at least two words of interest words to ensure at least two words are input.

5. The method of claim 1, further comprising:
visually displaying the least two words are input; and
receiving a signal accepting, rejecting or changing the at least two words.

6. The method of claim 1, further comprising:
employing a lexical database of nouns, verbs, adjectives and adverbs grouped into sets of cognitive synonyms (synsets), each expressing a distinct concept, where the synsets are interlinked by conceptual-semantic and lexical relations, to determine a link between the at least two words to identify the subject word and the object word.

7. The method of claim 6, further comprising:
utilizing an order of the input of the at least two words to identify the subject word and the object word.

8. The method of claim 1, further comprising:
employing an image search application programing interface to search the database for the images corresponding to the at least two words.

9. The method of claim 1, where the database is local to the computing system.

10. The method of claim 1, where the database is remote from the computing system.

11. The method of claim 1, where the database includes images personal to a user of the system.

12. The method of claim 1, further comprising:
visually displaying the first and second images; and
receiving an input accepting, rejecting or changing the first and second images.

13. The method of claim 1, wherein the imagery mnemonic is created by:
identifying a region of interests on the subject in the first image; and
merging the second image at the region of interest in the first image.

14. The method of claim 13, further comprising:
employing Poisson blending to merge the second image at the region of interest in the first image.

15. The method of claim 13, further comprising:
employing at least one of a magic wand, a stamping, a blending, a layer masking, a clone, a chopping, a warping, a flip, or an opacity to merge the second image at the region of interest in the first image.

16. The method of claim 1, further comprising:
employing a trained classifier to classify the images from the search results.

17. The method of claim 16, wherein the trained classifier is a cascade classifier.

18. The method of claim 15, wherein the training includes:
training the classifier to learn what an entity is with a set of images that include the entity;
segmenting the entity into segmented portions, each representing a different characteristic of the entity; and
training the classifier to learn what the segmented portions are with the segmented portions.

19. A computing system, comprising:
a memory device configured to store instructions, including an imagery mnemonic module; and
a processor configured to execute the instructions to cause the processor to:
receive at least two words of interest via an input device;
evaluate the at least two words to determine what entities they represent;
identify one of the at least two words as a subject word and another of the at least two words as an object word using a subject-object model;
search a database of images for images corresponding to the at least two words;
identify a classifier for each of the at least two words;
classify the images from the search results, including identifying a subject image that includes the entity represented by the subject word and an object image that includes the entity represented by the object word;
identify a location on the subject image for the object image; and
create a composite image by merging the object image at the identified location on the subject image, wherein the composite image represents an imagery mnemonic.

20. A computer readable storage medium encoded with computer readable instructions, which, when executed by a processor of a computing system, causes the processor to:
receive at least two words of interest input via an input device;
evaluate the at least two words to determine what entities they represent;
identify one of the at least two words as a subject word and another of the at least two words as an object word using a subject-object model;
search a database of images for images corresponding to the at least two words;
identify a classifier for each of the at least two words;
classify the images from the search results, including identifying a subject image that includes the entity represented by the subject word and an object image that includes the entity represented by the object word;
identify a location on the subject image for the object image; and
create a composite image by merging the object image at the identified location on the subject image, wherein the composite image represents an imagery mnemonic.
